(19) United States
(12) Patent Application Publication
(10) Pub. No.: US 2025/0148339 A1
(43) Pub. Date: May 8, 2025

(54) Machine-Learning Based Quantum Noise Decoder

(71) Applicant: Quantinuum LLC, Broomfield, CO (US)

(72) Inventors: Megan KOHAGEN, Robbinsdale, MN (US); Natalie Christine BROWN, Denver, CO (US); Ciaran RYAN-ANDERSON, Broomfield, CO (US)

(21) Appl. No.: 18/339,693

(22) Filed: Jun. 22, 2023

Related U.S. Application Data
(60) Provisional application No. 63/367,770, filed on Jul. 6, 2022.

(51) Int. Cl. G06N 10/60; G06N 10/70

(52) U.S. Cl. CPC G06N 10/60; G06N 10/70

(57) ABSTRACT

A quantum noise decoder comprising a machine-learning trained quantum error determination model is trained using training data comprising empirical operational data captured based at least in part on operation of a particular quantum processor. A noise model for the particular quantum processor is generated based on the machine-learning trained quantum error determination model. The noise model is provided. Providing the noise model comprises at least one of (a) causing a graphical representation of the noise model to be provided via a display of a computing entity such a component or parameter of the particular quantum processor is modified or changed based thereon or (b) providing the noise model as input associated with executable instructions for execution by a controller of the particular quantum processor or a computing entity in communication with the controller such that a component or parameter of the particular quantum processor is modified or changed based thereon.

### CROSS-REFERENCE TO RELATED APPLICATIONS

This application claims priority to U.S. Application No. 63/367,770, filed Jul. 6, 2022, the content of which is hereby incorporated by reference in its entirety.

### TECHNICAL FIELD

Various embodiments relate to the use of a machine-learning trained model to characterize the noise of a quantum processor. Various embodiments relate to using the characterization of the noise of a quantum processor to reduce the noise in the quantum processor. For example, an example embodiment relates to a quantum noise detector that comprises a machine-learning trained model that is trained using operational data for a particular quantum processor and that is configured for use in determining a noise model for the particular quantum processor.

### BACKGROUND

Large-scale quantum computers are expected to solve problems that are currently intractable with today's technology, such as in the fields of chemistry, material science, and biology. Solving such problems will entail computations employing quantum algorithms implemented using deep quantum circuits. Obtaining the necessary levels of accuracy for these deep circuits requires high levels of reliability for the quantum operations. To achieve such reliability, quantum error correction (QEC) will be employed during computations to suppress noise to required levels. Through applied effort, ingenuity, and innovation many deficiencies of prior QEC processes and quantum computer controllers configured to perform QEC have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products and/or the like for characterizing the noise of a quantum processor such that at least one component and/or parameter of the quantum processor and/or the controller of the quantum computer may be modified and/or changed so that the overall noise of the quantum processor is reduced. In various embodiments the noise of the quantum processor is characterized by a noise model. The noise model is generated, at least in part, based on a quantum error determination model that is trained using a machine-learning technique. The quantum error determination model is trained using training data that comprises empirical operational data for the quantum processor. In particular, the training data comprises empirical operational data that characterizes operation of the particular quantum processor (e.g., for the particular instance of hardware and hardware configuration) for which at least one component and/or parameter is to be modified, adjusted, and/or changed.

According to a first aspect of the present disclosure, a method for reducing the noise present in computations performed by a particular quantum processor is provided. In an example embodiment, the method comprises training, by one or more processors, a quantum noise decoder comprising a machine-learning trained quantum error determination model using training data comprising operational data captured based at least in part on operation of a particular quantum processor; generating, by the one or more processors, a noise model for the particular quantum processor based on the machine-learning trained quantum error determination model; and causing, by the one or more processors, the noise model to be provided. Providing the noise model comprises at least one of (a) causing a graphical representation of at least a portion of the noise model to be provided via a display of a computing entity such that at least one component or parameter of the particular quantum processor is modified or changed based thereon or (b) providing at least a portion of the noise model as input associated with executable instructions for execution by a controller of the particular quantum processor or a computing entity in communication with the controller of the particular quantum processor such that at least one component or parameter of the particular quantum processor is modified or changed based thereon.

In an example embodiment, the operational data comprises calibration data generated through operation of the particular quantum processor.

In an example embodiment, the calibration data is captured periodically during operation of the particular quantum processor.

In an example embodiment, the operational data comprises spectator objects data captured through direct or indirect observation of one or more spectator objects controlled by the particular quantum processor, the one or more spectator objects controlled independently of a quantum algorithm being executed by the particular quantum processor.

In an example embodiment, the quantum noise decoder comprises a generative adversarial network (GAN) comprising a generator and a discriminator and the generator is configured to generate simulated operational data.

In an example embodiment, the discriminator comprises or is in communication with the machine-learning trained quantum error determination model.

In an example embodiment, the quantum noise decoder comprises a noise model generation module configured to generate the noise model for the particular quantum processor based at least in part on output of the machine-learning trained quantum error determination model.

In an example embodiment, at least one component or parameter is part of or used by a real-time quantum error decoder to correct for quantum errors during operation of the particular quantum processor.

In an example embodiment, the at least one component or parameter is a hardware component or a physical parameter of the particular quantum processor.

In an example embodiment, at least one component or parameter corresponds to a re-calibration of a hardware component of the particular quantum processor or a software process of the controller of the particular quantum processor.

In an example embodiment, the quantum noise decoder is a real-time quantum error decoder configured to cause correction of quantum errors during operation of the particular quantum processor.

In an example embodiment, wherein the noise model characterizes noise present in the operational data for the particular quantum processor.

According to another aspect, an apparatus is provided. In an example embodiment, the apparatus comprises at least one non-transitory memory storing computer-executable instructions and a processing device. The computer-executable instructions, when executed by the processing device, configured to cause the apparatus to at least train a quantum noise decoder comprising a machine-learning trained quantum error determination model using training data comprising operational data captured based at least in part on operation of a particular quantum processor; generate a noise model for the particular quantum processor based on the machine-learning trained quantum error determination model; and cause the noise model to be provided. Providing the noise model comprises at least one of (a) causing a graphical representation of at least a portion of the noise model to be provided via a display of a computing entity such that at least one component or parameter of the particular quantum processor is modified or changed based thereon or (b) providing at least a portion of the noise model as input associated with executable instructions for execution by a controller of the particular quantum processor or a computing entity in communication with the controller of the particular quantum processor such that at least one component or parameter of the particular quantum processor is modified or changed based thereon.

In an example embodiment, the operational data comprises calibration data generated through operation of the particular quantum processor.

In an example embodiment, the calibration data is captured periodically during operation of the particular quantum processor.

In an example embodiment, the operational data comprises spectator objects data captured through direct or indirect observation of one or more spectator objects controlled by the particular quantum processor, the one or more spectator objects controlled independently of a quantum algorithm being executed by the particular quantum processor.

In an example embodiment, the quantum noise decoder comprises a generative adversarial network (GAN) comprising a generator and a discriminator and the generator is configured to generate simulated operational data.

In an example embodiment, the discriminator comprises or is in communication with the machine-learning trained quantum error determination model.

In an example embodiment, the quantum noise decoder comprises a noise model generation module configured to generate the noise model for the particular quantum processor based at least in part on output of the machine-learning trained quantum error determination model.

In an example embodiment, at least one component or parameter is part of or used by a real-time quantum error decoder to correct for quantum errors during operation of the particular quantum processor.

In an example embodiment, the at least one component or parameter is a hardware component or a physical parameter of the particular quantum processor.

In an example embodiment, at least one component or parameter corresponds to a re-calibration of a hardware component of the particular quantum processor or a software process of the controller of the particular quantum processor.

In an example embodiment, the quantum noise decoder is a real-time quantum error decoder configured to cause correction of quantum errors during operation of the particular quantum processor.

In an example embodiment, wherein the noise model characterizes noise present in the operational data for the particular quantum processor.

According to another aspect, a computer program product is provided. In an example embodiment, the computer program product comprises a non-transitory computer-readable medium storing computer-executable instructions. The computer-executable instructions are configured, when executed by a processing device of an apparatus, to cause the apparatus to train a quantum noise decoder comprising a machine-learning trained quantum error determination model using training data comprising operational data captured based at least in part on operation of a particular quantum processor; generate a noise model for the particular quantum processor based on the machine-learning trained quantum error determination model; and cause the noise model to be provided. Providing the noise model comprises at least one of (a) causing a graphical representation of at least a portion of the noise model to be provided via a display of a computing entity such that at least one component or parameter of the particular quantum processor is modified or changed based thereon or (b) providing at least a portion of the noise model as input associated with executable instructions for execution by a controller of the particular quantum processor or a computing entity in communication with the controller of the particular quantum processor such that at least one component or parameter of the particular quantum processor is modified or changed based thereon.

In an example embodiment, the operational data comprises calibration data generated through operation of the particular quantum processor.

In an example embodiment, the calibration data is captured periodically during operation of the particular quantum processor.

In an example embodiment, the operational data comprises spectator objects data captured through direct or indirect observation of one or more spectator objects controlled by the particular quantum processor, the one or more spectator objects controlled independently of a quantum algorithm being executed by the particular quantum processor.

In an example embodiment, the quantum noise decoder comprises a generative adversarial network (GAN) comprising a generator and a discriminator and the generator is configured to generate simulated operational data.

In an example embodiment, the discriminator comprises or is in communication with the machine-learning trained quantum error determination model.

In an example embodiment, the quantum noise decoder comprises a noise model generation module configured to generate the noise model for the particular quantum processor based at least in part on output of the machine-learning trained quantum error determination model.

In an example embodiment, at least one component or parameter is part of or used by a real-time quantum error decoder to correct for quantum errors during operation of the particular quantum processor.

In an example embodiment, the at least one component or parameter is a hardware component or a physical parameter of the particular quantum processor.

In an example embodiment, the at least one component or parameter corresponds to a re-calibration of a hardware component of the particular quantum processor or a software process of the controller of the particular quantum processor.

In an example embodiment, the quantum noise decoder is a real-time quantum error decoder configured to cause correction of quantum errors during operation of the particular quantum processor.

In an example embodiment, wherein the noise model characterizes noise present in the operational data for the particular quantum processor.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example quantum computing system comprising a quantum system controller according to an example embodiment.

FIG. 2 is a flowchart illustrating processes, procedures, and/or operations performed by a controller of FIG. 8 or a computing entity of FIG. 9, for example, for providing a noise model characterizing the noise of a particular quantum processor using a quantum noise decoder, according to various embodiments.

FIG. 3 is flowchart illustrating various processes, operations, and/or procedures performed by a controller of FIG. 8 or a computing entity of FIG. 9, for example, to obtain empirical operational data corresponding to operation of the particular quantum processor, according to various embodiments.

FIG. 4A is flowchart illustrating various processes, operations, and/or procedures for providing a noise model characterizing the noise of a particular quantum processor by operating a quantum noise decoder by a controller of FIG. 8 or a computing entity of FIG. 9, for example, according to various embodiments.

FIG. 4B is a block diagram schematically illustrating at least a portion of the architecture of a quantum noise decoder, according to various embodiments.

FIG. 5A is flowchart illustrating various processes, operations, and/or procedures for providing a noise model characterizing the noise of a particular quantum processor by operating a quantum noise decoder comprising a generative adversarial network (GAN) by a controller of FIG. 8 or a computing entity of FIG. 9, for example, according to various embodiments.

FIG. 5B is a block diagram schematically illustrating at least a portion of the architecture of a quantum noise decoder, according to various embodiments.

FIG. 6 is flowchart illustrating various processes, operations, and/or procedures performed by a controller of FIG. 8 or a computing entity of FIG. 9, for example, to provide a noise model such that at least one component and/or parameter of the quantum processor is modified, changed, adjusted, and/or the like based on the noise model, according to various embodiments.

FIG. 7 is flowchart illustrating various processes, operations, and/or procedures performed by a controller of FIG. 8 or a computing entity of FIG. 9, for example, to provide a noise model such that at least one component and/or parameter of the quantum processor is modified, changed, adjusted, and/or the like based on the noise model, according to various embodiments.

FIG. 8 provides a schematic diagram of an example controller of a quantum computer, according to various embodiments.

FIG. 9 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Example embodiments provide methods, systems, apparatuses, computer program products and/or the like for characterizing the noise of a quantum processor such that at least one component and/or parameter of the quantum processor and/or the controller of the quantum computer may be modified and/or changed so that the overall noise of the quantum processor is reduced. In various embodiments the noise of the quantum processor is characterized by a noise model. The noise model is generated, at least in part, based on a quantum error determination model that is trained using a machine-learning technique. The quantum error determination model is trained using training data that comprises empirical operational data for the quantum processor. In particular, the training data comprises empirical operational data that characterizes operation of the particular quantum processor (e.g., for the particular instance of hardware and hardware configuration) for which at least one component and/or parameter is to be modified, adjusted, and/or changed.

Large-scale quantum computers are expected to solve problems that are currently intractable with today's technology, such as in the fields of chemistry, material science, and biology. Solving such problems will entail computations employing quantum algorithms implemented using deep quantum circuits. Obtaining the necessary levels of accuracy for these deep circuits requires high levels of reliability for the quantum operations. To achieve such reliability, quantum error correction (QEC) will be employed during computations to suppress noise to required levels. However, to suppress the noise present within a particular quantum processor to the required levels, it is helpful to understand the noise present in the particular quantum processor.

As used herein, a particular quantum processor corresponds to a particular instance of hardware and the configuration of that hardware to provide the particular quantum processor. For example, in the field of quantum charge-coupled device (QCCD)-based quantum computing, a particular quantum processor corresponds to a particular ion trap, the magnetic field generation components, manipulation sources (e.g., lasers), the optical paths defined to provide manipulation signals (e.g., laser beams) to respective locations of the particular ion trap, and/or the like. For example, if a particular mirror or lens of an optical path is slightly out of alignment or an optical fiber defining a portion of an optical path is nearly burnt out, the manipulation signal provided along the optical path may carry less optical power than expected and/or result in uncompensated shifts in optical phase of the manipulation signal. Thus, the functions performed using the optical path contribute to the noise of the particular quantum processor. However, a second quantum processor of similar design would not experience that particular contribution to the noise of the second quantum processor.

Current techniques for managing noise in a quantum processor include the use of real-time quantum error decoders. However, due to the time constraints for performing real-time quantum error correction while executing a quantum circuit, current real-time quantum error decoders tend to be simple programs that rely on algorithms such as the blossom algorithm or Dijkstra's algorithm. These real-time quantum error decoders are generally not able to provide a broader characterization of the noise of a particular quantum processor and may rely on generic noise models that fail to characterize noise contributions that are distinct and/or specific to the particular quantum processor with which the real-time quantum error decoder is associated. Therefore, there exist technical problems in the field of characterizing the noise of a quantum processor and using a noise model that characterizes the noise of a quantum processor to perform quantum error correction (including real-time quantum error correction) for a quantum processor.

Various embodiments provide technical solutions to these technical problems. In particular, various embodiments provide a quantum noise decoder that comprises a machine-learning based quantum error determination model that is trained, using a machine-learning technique, to characterize the noise of the particular quantum processor. The quantum noise decoder (e.g., the machine-learning based quantum error determination model) is trained using operational data (e.g., empirical operational data) corresponding to and/or generated during operation of a particular quantum processor. The quantum noise decoder is then used to generate a noise model that characterizes the noise of the particular quantum processor.

Based on the noise for the particular quantum processor, at least one component and/or parameter of the quantum processor may be modified, adjusted, changed, and/or the like to reduce the noise in the computations performed by the particular quantum processor. For example, a graphical representation of at least a portion of the noise model for the particular quantum processor may be displayed via a graphical user interface (GUI) and/or the like provided via the display of a computing entity such that a human technician may modify, adjust, change, and/or the like at least one component and/or parameter. For example, the human technician may change or adjust a physical component and/or parameter of the particular quantum processor. For example the human technician may change out a burnt out optical fiber, adjust the alignment of a mirror or lens, and/or the like based on a contribution to the noise of the particular quantum processor identified and/or indicated by the noise model. For example, the controller of the quantum computer may modify, adjust, change, and/or the like at least one component and/or parameter of the quantum processor (e.g., adjust a hardware component and/or parameter, software component and/or parameter, and/or a calibration component and/or parameter) based on the noise model. In an example embodiment, the noise model is provided to the real-time quantum error decoder for use in performing real-time quantum error correction for the particular quantum processor. In various embodiments, the real-time quantum error correction comprises tracking one or more quantum errors, phase shifts, and/or the like in software and physically applying quantum error corrections to the appropriate qubits at appropriate points during the performance of a quantum circuit.

Thus, various embodiments provide methods, apparatuses, systems, computer program products, and/or the like for determining a noise model that characterizes the noise of a particular quantum processor. Various embodiments provide methods, apparatuses, systems, computer program products, and/or the like for reducing the noise of a particular quantum processor based on a determined noise model that characterizes the noise of the particular quantum processor. Various embodiments therefore provide practical applications that provide technical solutions and technical advantages to quantum computing, including the fields of quantum error correction, real-time quantum error correction, quantum processor noise reduction, and/or the like.

Various embodiments are described in detail herein with respect to a QCCD-based quantum processor. However, one of ordinary skill in the art would understand, based on the disclosure provided herein, that various embodiments may be used to characterize and/or reduce the noise of various types of quantum processors (including but not limited to superconducting quantum processors (e.g., using Josephson junctions as qubits), neutral atoms in optical lattices quantum processors, spin-based or spatial-based quantum dot quantum processors, nuclear magnetic resonance quantum processors, etc.).

### Example Quantum Computing System Comprising an Atomic Object Confinement Apparatus

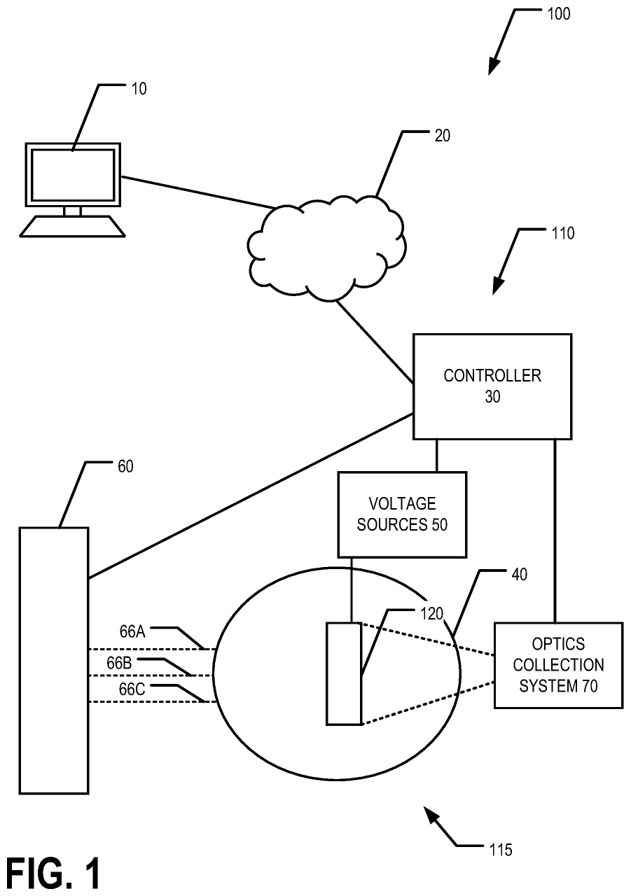

FIG. 1 provides a schematic diagram of an example quantum computing system 100. The quantum computing system 100 comprises one or more computing entities 10 and a quantum computer 110. The quantum computer comprises a controller 30 and a quantum processor 115. In various embodiments, the controller 30 is programed and/or configured to control operation of various components, assemblies, elements, and/or the like of the quantum processor 115. The computing entity 10 is in wired and/or wireless communication with the controller 30 of the quantum computer 110.

In the illustrated embodiment, the quantum computer 110 is a QCCD-based quantum computer and the quantum processor 115 comprises an atomic object confinement apparatus 120 (e.g., an ion trap and/or the like) having a plurality of atomic objects (e.g., atoms, ions, and/or the like) confined therein. In an example embodiment, the quantum processor 115 comprises a plurality of qubits (e.g., data qubits that may be organized into logical qubits, ancilla qubits, and/or the like). For example, at least some of the atomic objects (e.g., atoms, ions, and/or the like) confined by the atomic object confinement apparatus 120 (e.g., an ion trap and/or the like) are used as qubits of the quantum processor 115.

In various embodiments, the quantum processor 115 comprises means for controlling the evolution of quantum states of the qubits. For example, in an example embodiment, the quantum processor 115 comprises a cryostat and/or vacuum chamber 40 enclosing the confinement apparatus 120 (e.g., an ion trap), one or more manipulation sources 60, one or more voltage sources 50, and/or one or more optics collection systems 70. For example, the cryostat and/or vacuum chamber 40 may be a temperature and/or pressure-controlled chamber. In an example embodiment, the one or more manipulation sources 60 may comprise one or more lasers (e.g., optical lasers, microwave sources, and/or the like). In various embodiments, the one or more manipulation sources 60 are configured to manipulate and/or cause a controlled quantum state evolution of one or more atomic objects within the confinement apparatus. In various embodiments, the atomic objects within the confinement apparatus (e.g., ions trapped within an ion trap) act as the data qubits and/or ancilla qubits of the quantum processor 115 of the quantum computer 110. For example, in an example embodiment, wherein the one or more manipulation sources 60 comprise one or more lasers, the lasers may provide one or more laser beams to atomic objects trapped within the confinement apparatus 120 within the cryostat and/or vacuum chamber 40. For example, the manipulation sources 60 may generate and/or provide laser beams configured to ionize atomic objects, initialize atomic objects within the defined two state qubit space of the quantum processor, perform gates on one or more qubits of the quantum processor, read a quantum state of one or more qubits of the quantum processor, and/or the like.

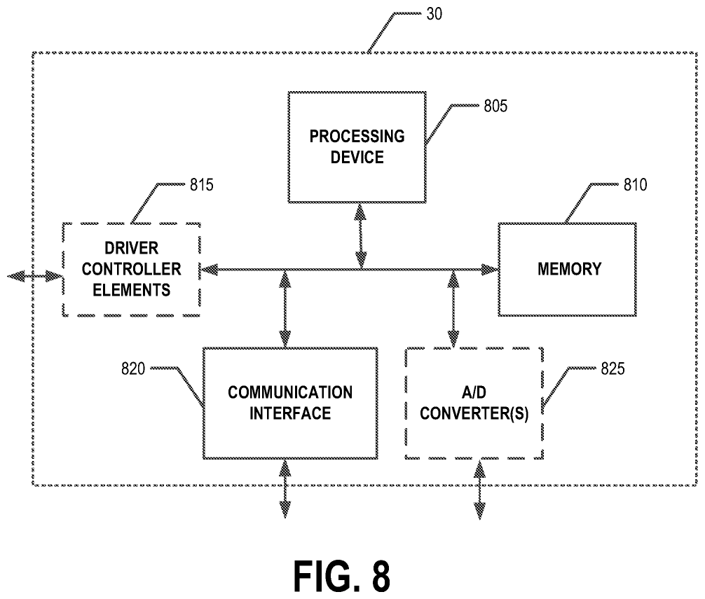

In various embodiments, the quantum processor 115 comprises an optics collection system 70 configured to collect and/or detect photons generated by qubits (e.g., during reading procedures). The optics collection system 70 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits of the quantum processor 115. In various embodiments, the detectors may be in electronic communication with the controller 30 via one or more A/D converters 825 (see FIG. 8) and/or the like.

In various embodiments, the quantum processor 115 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding potential generating elements (e.g., electrodes) of the confinement apparatus 120, in an example embodiment.

In various embodiments, a computing entity 10 is configured to allow a user to provide input to the quantum computer 110 (e.g., via a user interface of the computing entity 10) and receive, view, and/or the like output from the quantum computer 110. In various embodiments, the computing entity 10 is configured to train and/or communicate with a quantum noise decoder. For example, in various embodiments, the computing entity 10 is configured to provide empirical operational data captured by one or more sensors coupled to the particular quantum processor 115 to the quantum noise decoder and receive output of the quantum noise decoder that includes a noise model for the particular quantum processor 115. In an example embodiment, the computing entity 10 is configured to provide the noise model such that at least one component and/or parameter of the particular quantum processor 115 is modified, adjusted, changed, and/or the like based on the noise model.

The computing entity 10 may be in communication with the controller 30 of the quantum computer 110 and/or other computing entities 10 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control the voltage sources 50, cryostat system and/or vacuum system controlling the temperature and pressure within the cryostat and/or vacuum chamber 40, manipulation sources 60, and/or other systems controlling various environmental conditions (e.g., temperature, pressure, magnetic field, and/or the like) within the cryostat and/or vacuum chamber 40 and/or configured to manipulate and/or cause a controlled evolution of quantum states of one or more atomic objects within the confinement apparatus. For example, the controller 30 may cause a controlled evolution of quantum states of one or more atomic objects within the confinement apparatus 120 to execute a quantum circuit and/or algorithm. For example, the controller 30 may cause a reading procedure comprising coherent shelving to be performed, possibly as part of executing a quantum circuit and/or algorithm.

Additionally, the controller 30 is configured to communicate and/or receive input data from the optics collection system 70 and corresponding to the reading of the quantum state of qubits of the quantum processor 115. In various embodiments, the controller 30 is configured to control calibration of one or more components and/or parameters of the quantum processor 115. In various embodiments, the controller 30 is configured to modify, adjust, change, and/or the like one or more hardware, software, calibration, and/or operational components and/or parameters of the quantum processor 115 based at least in part on processing and/or analyzing a noise model of the quantum processor 115.

### Example Operation and Use of a Quantum Noise Decoder

In various embodiments, a quantum noise decoder comprising a machine-learning based quantum error determination model is provided and/or used to modify, adjust, change, and/or the like at least one component and/or parameter of the particular quantum processor 115 based on a noise model for the particular quantum processor provided, generated and/or determined by the quantum noise decoder. In various embodiments, the quantum noise decoder is trained and/or operated by the computing entity 10 (e.g., via execution of computer-executable instructions by the processing device 908) and/or the controller 30 (e.g., via execution of computer-executable instructions by the processing device 805).

In various embodiments, the quantum noise decoder is trained using operational data corresponding to the operation of a particular quantum processor 115. The particular quantum processor 115 is the quantum processor controlled by the controller 30. In various embodiments, training the quantum noise decoder comprises using a machine-learning technique to train a quantum error determination model. In various embodiments, the quantum error determination model is trained using training data. The training data comprises empirical operational data that corresponds to the operation of the particular quantum processor 115.

In various embodiments, the empirical operational data comprises circuit performance data generated during the execution of a quantum circuit by the particular quantum processor 115. For example, while the particular quantum processor 115 executes a quantum circuit, one or more sensors coupled to the quantum processor 115 (e.g., in communication with the controller 30) capture circuit performance data and provides the circuit performance data to the controller 30. In various embodiments, the circuit performance data includes the results of performing reading operations on one or more qubits of the quantum processor, optical power readings indicating the optical power of various manipulation signals applied to one or more qubits during execution of the quantum circuit, characterization of the performance of the circuit, and/or the like.

In various embodiments, the empirical operational data comprises calibration data generated by performing a calibration of the particular quantum processor 115. For example, at one or more of before execution of a quantum circuit, after execution of a quantum circuit, at one or more set points during execution of the quantum circuit, and/or periodically during execution of the quantum circuit, calibration processes may be triggered. During an example calibration process, one or more set operations are performed and sensors coupled to the particular quantum processor 115 capture calibration data. For example, the power of a particular manipulation signal at a particular position along an optical path may be measured, the electric field generated by applying a particular voltage signal to one or more potential generating elements (e.g., electrodes) of the confinement apparatus 120 may be measured and/or determined, alignment of various components (e.g., defining an optical path) of the particular quantum processor 115 may be checked, and/or the like. Such calibration processes result in the generation of calibration data that is included in the empirical operational data corresponding to operation of the particular quantum processor 115, in various embodiments. Some non-limiting examples of calibration processes include single qubit gate fidelity tests, two qubit gate fidelity tests, measurements regarding fluctuations of the magnetic field at one or more locations of the confinement apparatus 120 over a period of time, atomic object (e.g., qubit) dephasing noise, and/or the like.

In various embodiments, the calibration data comprises data captured by one or more (classical) sensors and that characterizes the environment (e.g., magnetic field, temperature, pressure, ambient light, electric field, voltage change across a portion of the confinement apparatus 120 surface, and/or the like) at one or more locations of the confinement apparatus. For example, one or magnetometers, voltage sensors, piezoelectric thermal and/or pressure sensors, and/or the like coupled to and/or in communication with the environment surrounding the confinement apparatus 120 (e.g., inside the cryostat and/or vacuum chamber 40) are used to capture at least a portion of the calibration data.

In various embodiments, the calibration data includes spectator object data. In various embodiments, one or more spectator objects are confined by the confinement apparatus 120. As used herein a spectator object is an atomic object (e.g., atom, ion, and/or the like) that is not used as a qubit of the quantum processor 115 and that is not used as a sympathetic cooling atomic object of the quantum processor 115 (e.g., configured to be used in laser cooling a corresponding qubit via sympathetic cooling). In an example embodiment, one or more spectator objects are of a different chemical species than the atomic objects used as qubits and/or sympathetic cooling atomic objects of the quantum processor 115. In an example embodiment, the spectator objects comprise atomic objects of one or more chemical species that may be sensitive to various environmental characteristics (e.g., magnetic field strength, fluctuations/noise in magnetic field, fluctuations/noise in the electric potential, temperature, fluctuations/noise in temperature, and/or the like).

In various embodiments, the spectator objects are used to probe various aspects of the operation of the particular quantum processor 115. For example, the calibration processes may include performing one or more functions on one or more spectator objects confined by the confinement apparatus 120 and measuring a response of the one or more spectator objects to the performance of the one or more functions. For example, one or more manipulation signals may be incident on a spectator object or group of two or more spectator objects and any fluorescence (e.g. light emitted by the spectator object(s) in response to the one or more manipulation signals being incident thereon) may be captured and/or measured. In another example, the movement of one or more spectator objects within the confinement apparatus 120 as a result of voltage signals applied to potential generating elements (e.g., electrodes) of the confinement apparatus 120 may be determined and/or measured. In various embodiments, the data captured regarding the response of the one or more spectator objects to various functions being performed thereon is referred to as spectator objects data herein. In various embodiments, the calibration data comprises spectator objects data. In various embodiments, the spectator objects data is used to supplement and/or as part of the calibration data.

The quantum noise decoder is configured to receive the empirical operational data corresponding to (e.g., captured during) operation of the particular quantum processor 115 and, based at least in part thereon, generate and/or determine and provide a noise model. The noise model characterizes the noise of the particular quantum processor 115 that is present in the operational data. In various embodiments, the noise model represents a probability distribution of the character of noise over multivariate time series of input data that may be used, for example, to determine when the particular quantum processor 115 is operating within the set bounds or outside of set bounds. For example, the noise model may be used to identify anomalies in operation of the particular quantum processor 115. For example, in an example embodiment, the noise model is an anomaly detection model configured to determine when the particular quantum processor 115 is operating outside of statistically normal or predetermined normal bounds. For example, in various embodiments, the noise model is a time and/or space parameterized distribution of how noise affects and/or is applied to calculations performed by the particular quantum processor 115. For example, the noise model may indicate a frequency profile of noise present in electrical signals applied to the potential generating elements of the confinement apparatus 120; wavelength/frequency fluctuations, phase shifts, and/or optical power fluctuations in various manipulation signals; magnitude, direction, and/or frequency profiles of magnetic field fluctuations at one or more locations within the confinement apparatus 120; variations in quantum state readings of a cohort of physical qubits that are used as logical qubit and/or a cohort of spectator objects; and/or the like. In various embodiments, the noise model is parameterized at least in space and/or time. For example, different and/or independent noise profiles may be associated with different zones of the confinement apparatus 120. For example, the evolution of noise at one or more locations within the confinement apparatus 120 over time may be determined and/or tracked.

In various embodiments, the noise model may indicate trends in various noise types and/or contributors over time. For example, the empirical operational data may correspond to operation of the particular quantum processor 115 over a first period of time and the noise model may indicate how the noise of the particular quantum processor 115 evolved over the first period of time and/or how the noise of the particular quantum processor 115 is expected to evolve in a second period of time (preceding or succeeding the first period of time).

In various embodiments, the noise model includes a description of the noise present in the operation of various sub-systems and/or assemblies of the particular quantum processor 115. For example, the noise model may include noise profiles of wavelength/frequency fluctuations, phase shifts, and/or optical power fluctuations in manipulation signals used to perform two-qubit gates and noise profiles of wavelength/frequency fluctuations, phase shifts, and/or optical power fluctuations in manipulation signals used to perform qubit reading operations. In various embodiments, the noise model may include an indication of a source or contributor of a feature in a profile. For example, the machine-learning trained quantum error determination model is trained, in an example embodiment, to identify instances where the noise profile of a sub-system of the particular quantum processor 115 is larger than a baseline noise amplitude, includes an identifiable feature (e.g., the phase shift profile includes larger than average amplitude peaks at points that correspond in time to larger than average optical power fluctuations). For example, if the probability of applying various noise increases with run time of the particular quantum processor 115 (e.g., correlation between amplitude of noise and run time), the noise may be increasing due to heating. In another example, one or more measurements of one or more spectator objects may indicate that one or more quantum operations has an increased or decreased probability of applying a particular type of noise. Based on the noise profiles of the sub-system and/or correlations between noise profiles of the sub-system, the machine-learning trained quantum error determination model and/or noise model generation module is configured to identify likely noise sources for the sub-system of the particular quantum processor.

In various embodiments, the noise model for the particular quantum processor 115 is provided such that at least one component and/or parameter of the quantum processor may be modified, adjusted, changed, and/or the like to reduce the noise in the computations performed by the particular quantum processor.

For example, a graphical representation of at least a portion of the noise model for the particular quantum processor may be displayed via a graphical user interface (GUI) and/or the like provided via the display of a computing entity such that a human technician may modify, adjust, change, and/or the like at least one component and/or parameter. For example, the human technician may change out a burnt out optical fiber, adjust the alignment of a mirror or lens, and/or the like based on a contribution to the noise of the particular quantum processor identified and/or indicated by the noise model.

For example, the controller of the quantum computer may modify, adjust, change, and/or the like at least one component and/or parameter of the quantum processor (e.g., adjust a hardware component and/or parameter, software component and/or parameter, and/or a calibration component and/or parameter) based on the noise model. In an example embodiment, the noise model is provided to the real-time quantum error decoder for use in performing real-time quantum error correction for the particular quantum processor. For example, one or more parameters, weights, and/or the like of the quantum error decoder configured to perform quantum error correction for the particular quantum processor 115 may be updated, modified, changed, and/or the like based on the noise model. In an example embodiment, one or more calibration processes is performed more/less regularly (e.g., in accordance with a shorter/longer periodicity), performed a larger/smaller number of times each time the process is triggered, one or more new calibration processes may be defined, and/or the like based at least in part on the noise model. In an example embodiment, the technique for performing a function of the quantum computer (e.g., performing a single or two qubit gate, performing a transportation operation, performing a reading operation, and/or the like), may be modified, updated, changed, and/or the like based on the noise model so as to reduce the noise present in computation performed by the particular quantum processor 115.

### Determining a Noise Model for a Particular Quantum Processor and Using the Noise Model to Improve the Function of the Particular Quantum Processor

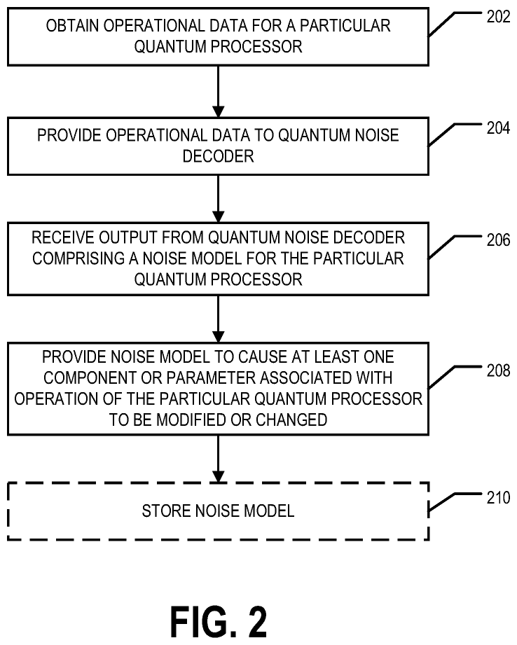

FIG. 2 provides a flowchart illustrating various processes, procedures, operations, and/or the like for using a quantum noise decoder to determine a noise model for a particular quantum processor 115 and using the noise model to improve the function of the particular quantum processor 115 (e.g., reduce the noise present in computation performed by the particular quantum processor 115.) In various embodiments, processes, procedures, operations, and/or the like illustrated in FIG. 2 are performed the computing entity 10 (e.g., via execution of computer-executable instructions by the processing device 908) and/or the controller 30 (e.g., via execution of computer-executable instructions by the processing device 805).

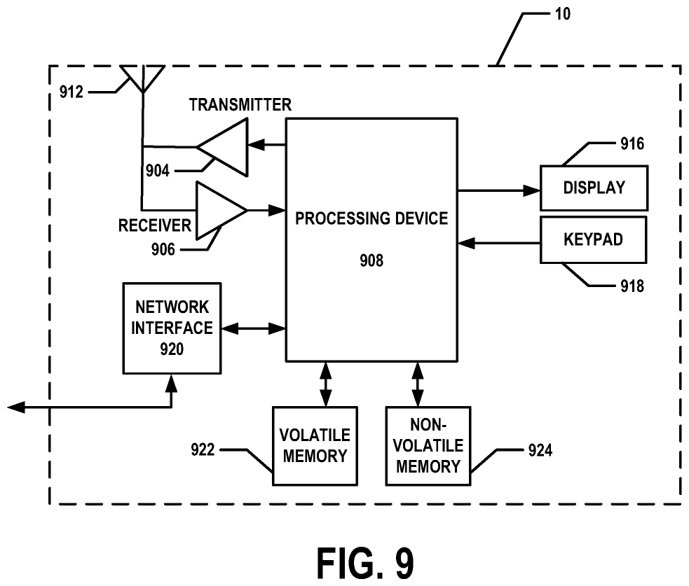

Starting at step/operation 202, operational data for a particular quantum processor is obtained. For example, the processing device 805 (see FIG. 8) of the controller 30 or processing device 908 (see FIG. 9) of the computing entity 10 obtains operational data for the particular quantum processor 115. In various embodiments, the operational data is obtained by accessing the operational data from memory 810, 922, 924. In various embodiments, the operational data is obtained by receiving the operational data via a communication interface 820, one or more A/D converters 825, network interface 920, receiver 906, and/or the like. In an example embodiment, the controller 30 and/or computing entity 10 may cause the particular quantum processor 115 to perform one or more calibration processes and/or to execute at least a portion of a quantum circuit and receive the operational data generated as a result of and/or during the performance of the one or more calibration processes and/or execution of the at least a portion of the quantum circuit. In various embodiments, the obtained operational data is empirical operational data corresponding to the operation of the particular quantum processor and therefore comprises a noise signature and/or profile that is unique to the particular quantum processor 115.

At step/operation 204, the operational data is provided to the quantum noise decoder. For example, in an example embodiment, the operational data is held available to the quantum noise decoder such that the quantum noise decoder can read in the operational data. In an example embodiment, the operational data is provided to the quantum noise decoder via an application program interface (API) call. One or more modules of the quantum noise decoder then use the operational data to train the machine-learning based quantum error determination model and to generate a noise model characterizing the noise of the particular quantum processor 115 (e.g., the unique noise signature and/or profile of the particular quantum processor). For example, the processing device 805, 908 may execute computer-executable instructions that cause the operational data to be provided to the quantum noise decoder such that the quantum noise decoder uses the operational data to generate and/or determine a noise model characterizing the noise of the particular quantum processor 115 (e.g., the unique noise signature and/or profile of the particular quantum processor).

At step/operation 206, output from the quantum noise decoder is received. The output from the quantum noise decoder includes the noise model for the particular quantum processor 115. For example, the output including the noise model for the particular quantum processor 115 may be stored to memory 810, 922, 924 and accessed by the processing device 805, 908. For example, the output including the noise model for the particular quantum processor 115 may be provided to the processing device 805, 908 via an API call or response.

At step/operation 208, at least a portion of the noise model is provided such that at least one component and/or parameter associated with the operation of the particular quantum processor is modified, adjusted, changed, and/or the like based at least in part on the noise model. For example, the noise model may be provided via communication interface 820, network interface 920, transmitter 904, and/or display 916, in various embodiments. For example, a graphical representation of at least a portion of the noise model for the particular quantum processor may be displayed via a graphical user interface (GUI) and/or the like provided via the display 916 of a computing entity 10 such that a human technician may modify, adjust, change, and/or the like at least one component and/or parameter associated with the operation of the particular quantum processor 115. For example, the human technician may change out a burnt out optical fiber, adjust the alignment of a mirror or lens, and/or the like based on a contribution to the noise of the particular quantum processor identified and/or indicated by the noise model.

In an example embodiment, the processing device 805, 908 may provide at least a portion of the noise model as input for a program, module, application, and/or the like operating thereon. For example, a calibration manager may receive the noise model as input and modify, adjust, change, and/or the like a component and/or parameter of a calibration process, generate a new calibration process, and/or the like based on the results of processing and/or analyzing the noise model.

For example, the controller 30 of the quantum computer may modify, adjust, change, and/or the like at least one component and/or parameter of the quantum processor (e.g., adjust a hardware component and/or parameter, software component and/or parameter, and/or a calibration component and/or parameter) based on the noise model. In an example embodiment, the noise model is provided to the real-time quantum error decoder (e.g., operating on the controller 30) for use in performing real-time quantum error correction for the particular quantum processor 115. In an example embodiment, the technique for performing a function of the quantum computer (e.g., performing a single or two qubit gate, performing a transportation operation, performing a reading operation, and/or the like), may be modified, updated, changed, and/or the like based on the noise model and/or a result of processing and/or analyzing the noise model so as to reduce the noise present in computation performed by the particular quantum processor 115. In an example embodiment, a new calibration process may be put into use to ensure proper functioning of a particular component, element, assembly, and/or the like of the particular quantum processor 115 based on the noise model and/or a result of processing and/or analyzing the noise model.

In an example embodiment, the controller 30 and/or computing entity 10 processes the noise model to determine whether there are components and/or parameters that may be automatically modified, adjusted, changed, and/or the like in an attempt to reduce the noise (e.g., reduce the amplitude of noise in one or more noise profiles provided by the noise model, reduce the presence of a particular feature present in one or more noise profiles provided by the noise model, and/or the like) experienced by the particular quantum processor 115. In an example embodiment, when it is determined that automated modifications, adjustments, changes and/or the like to one or more components and/or parameters may be made, the controller 30 and/or computing entity 10 may cause at least one of the one or more components and/or parameters to be modified, adjusted, changed, and/or the like accordingly, provide a human perceivable notification of and/or request for permission for automated performance of modification (e.g., via display 916), adjustment, change, and/or the like, and/or update a log with information regarding a performed automated modification, adjustment, change, and/or the like.

In various embodiments, when no automated modification, adjustment, change, and/or the like for at least one component and/or parameter is identified and/or when a possible manual modification, adjustment, change, and/or the like for at least one component and/or parameter is identified, a graphical representation of at least a portion of the noise model (e.g., possibly indicating the identified possible manual modification, adjustment, change, and/or the like) is displayed (e.g., via display 916) for human user review. In an example embodiment, regardless of the identified possible automated and/or manual modifications, adjustments, changes, and/or the like to one or more components and/or parameters of the particular quantum processor 115, a graphical representation of the at least a portion of the noise model is displayed (e.g., via display 916) for human user review.

At step/operation 210, the noise model may be stored to memory 810, 922, 924. For example, the controller 30 and/or computing entity 10 may store the noise model for future use. For example, the noise model may be accessed from memory at a later point in time to compare to a newly determine noise model, to be referenced by the (real-time) quantum error decoder of the quantum computer 110, and/or the like.

### Example Obtaining of Operational Data

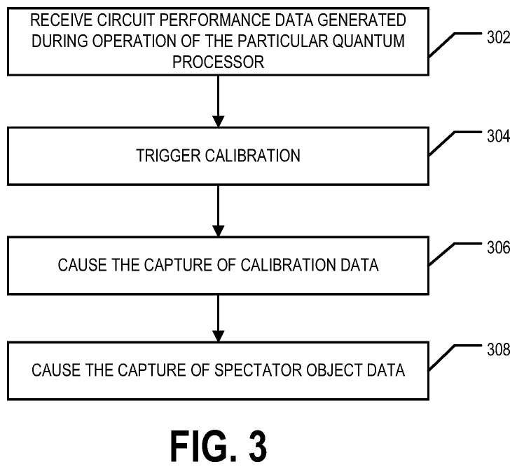

FIG. 3 provides a flowchart illustrating various processes, procedures, operations, and/or the like that are performed by a controller 30 and/or computing entity 10, in various embodiments, as part of obtaining empirical operational data for the particular quantum processor. For example, one or more of the steps/operations illustrated by FIG. 3 may be performed as part of step/operation 202 of FIG. 2, in various embodiments.

Starting at step/operation 302, circuit performance data generated during operation of the particular quantum processor is received. For example, the circuit performance data is received by the controller 30 via the A/D converters 825 and/or communication interface 820, in various embodiments. For example, the circuit performance data is received by the computing entity 10 via the network interface 920 and/or receiver 906, in various embodiments.

The circuit performance data is generated and/or captured by one or more sensors coupled to the particular quantum processor and configured to capture various measurements related to the operation of the particular quantum processor (e.g., electric field generated responsive to a series of voltage signals being applied to the potential generating elements (e.g., electrodes), optical power along a particular optical path, fluorescence of a qubit or spectator object, and/or the like). In various embodiments, the circuit performance data is stored to memory 810, 922, 924.

At step/operation 304, a calibration is triggered. For example, the calibration may be triggered periodically, in response to determination that an element of the circuit performance data is outside of a specified range, and/or the like. For example, the controller 30 and/or the computing entity 10 may trigger a calibration.

In various embodiments, triggering a calibration comprises causing a calibration process to be initiated. For example, the controller 30 and/or the computing entity 10 may cause one or more calibration processes to be initiated (e.g., cause at least a portion of the execution of quantum circuit to pause, cause a routine and/or scripted calibration process to be performed, and/or cause corresponding calibration data to be generated). For example, the controller 30 may determine that a substantial shift in qubit frequency occurred since the last calibration cycle. This may indicate a change in the magnetic field in at least a portion of the confinement apparatus 120 and may be used to trigger one or more calibration processes (e.g., to determine if there was a change in the magnetic field and/or the degree of change in the magnetic field).

In various embodiments, performing a calibration process comprises performing an operation a plurality of times such that a probability distribution and/or statistical analysis of the results of the operation may be determined. In another example, one or more environment characteristics may be checked to detect changes in the environment characteristics over a period of time. For example, the magnetic field at one or more locations in the confinement apparatus may be checked to see if the magnetic field has changed.

At step/operation 306, as a result of triggering the calibration, the controller 30 and/or the computing entity 10 causes calibration data to be generated and/or captured. For example, one or more sensors coupled to the particular quantum processor capture calibration data during and/or as part of one or more calibration processes. In an example embodiment, the calibration data is received by the controller 30 via the A/D converters 825 and/or communication interface 820, in various embodiments. In an example embodiment, the calibration data is received by the computing entity 10 via the network interface 920 and/or receiver 906, in various embodiments. In various embodiments, the calibration data is stored to memory 810, 922, 924.

In various embodiments, spectator object data is collected as part of one or more calibration processes. For example, the controller 30 may be configured to cause the performance of one or more calibration processes by the quantum processor 115 that include the capturing of spectator object data. At step/operation 308, as a result of triggering the calibration, the controller 30 and/or the computing entity 10 causes spectator object data to be generated and/or captured. For example, one or more sensors coupled to the particular quantum processor capture spectator object data during and/or as part of one or more calibration processes. In an example embodiment, the spectator object data is received by the controller 30 via the A/D converters 825 and/or communication interface 820, in various embodiments. In an example embodiment, the spectator object data is received by the computing entity 10 via the network interface 920 and/or receiver 906, in various embodiments. In various embodiments, the spectator object data is stored to memory 810, 922, 924.

In various embodiments, the operational data (e.g., circuit performance data, calibration data, and/or spectator object data) may be obtained by accessing the operational data from memory 810, 922, 924.

### Example Use of a Quantum Noise Decoder to Determine a Noise Model for a Particular Quantum Processor

In various embodiments, a quantum noise decoder is configured to receive operational data corresponding to and/or captured during operation of a particular quantum processor 115 as input and provide an output comprising a noise model characterizing the noise present in computations performed by the particular quantum processor 115. In various embodiments, the quantum noise decoder comprises a quantum error determination model that is a machine-learning trained model. At least a portion of the training data used to train the machine-learning trained quantum error determination model is empirical operational data corresponding to operation of the particular quantum processor 115. Thus, the quantum error determination model is particularly configured and/or trained to determine noise profiles and/or identify (potential) noise sources and/or contributors of the particular quantum processor 115.

In various embodiments, the quantum error determination model comprises one or more neural networks. In various embodiments, the quantum error determination model comprises one or more deep neural networks (DNN). In various embodiments, the quantum error determination model is and/or comprises one or more of a classifier DNN, convolutional neural network (CNN), a recurrent neural network (RNN), a long short-term memory network (LSTM), modular neural network, and/or neural network(s) of other architecture(s). In various embodiments, the quantum error determination model comprises a support vector machine, a kernel-based model (e.g., a one-class support vector configured to distinguish between “normal” and “not-normal” operation of the particular quantum processor 115), and/or the like. In an example embodiment, the quantum error determination model is trained using a supervised machine learning technique.

In various embodiments, the quantum noise decoder further comprises a noise model generation module. In various embodiments, the noise model generation module is configured to translate, transform, format, compile, and/or configure the output of the quantum error determination model into a noise model that is comprehensible to the controller 30 and/or computing entity 10 of the quantum computing system 100. In various embodiments, the noise model generation module comprises and/or is operated through execution of classically programmed computer-executable instructions (e.g., via processing device 805, 908). In various embodiments, the noise model generation module comprises one or more machine-learning trained models (e.g., neural networks), possibly in addition to classically programmed computer-executable instructions.

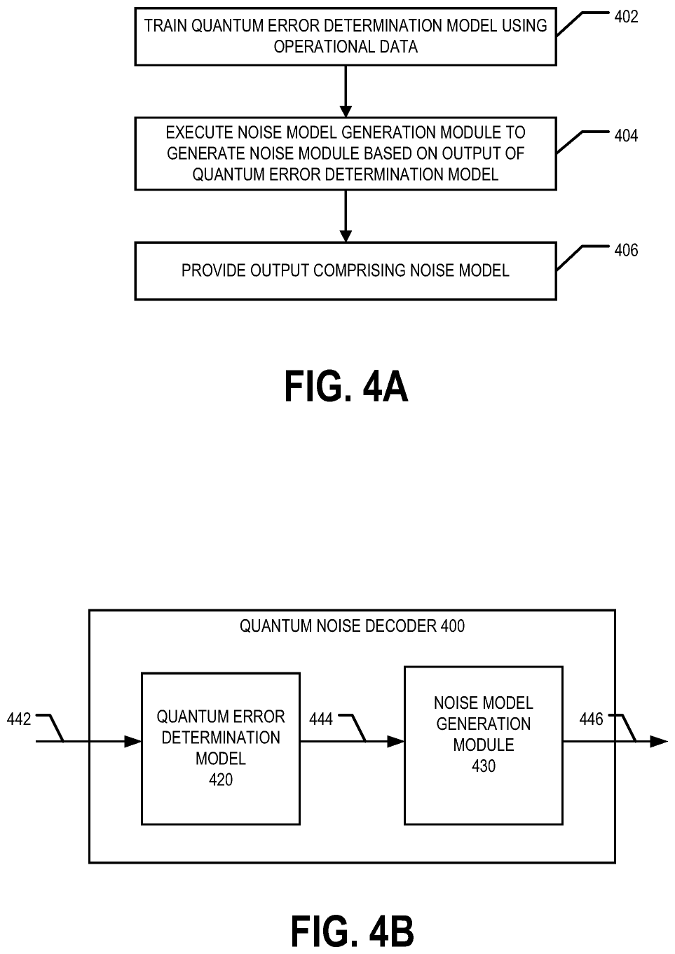

FIG. 4B illustrates an example architecture of at least a portion of an example quantum noise decoder 400 and FIG. 4A provides a flowchart illustrating various processes, procedures, operations, and/or the like of using the quantum noise decoder 400 to generate and/or provide a noise model for the particular quantum processor 115.

As shown in FIG. 4B, the example quantum noise decoder 400 comprises a quantum error determination model 420 and a noise model generation module 430. The quantum error determination model 420 is configured to receive input 442 (e.g., comprising operational data corresponding to the operation of the particular quantum processor 114). In an example embodiment, the quantum error determination model 420 comprises one or more neural networks (e.g., DNNs) and is configured to receive the input 442 via one or more input layers of the one or more neural networks. For example, the quantum error determination model 420 comprises an input layer, one or more hidden layers, and an output layer for each DNN thereof. Nodes of an input layer of a respective DNN of the quantum error determination model are linked to nodes of a first hidden layer of the respective DNN by respective weights. Nodes of the first hidden layer are linked to nodes of subsequent hidden layers of the respective DNN by respective weights and nodes of the final hidden layer are linked to nodes of the output layer of the respective DNN via respective weights. The respective weights are determined through a machine-learning technique and/or process. In an example embodiment, the machine-learning technique and/or process is iterative such that continued training of the quantum error determination model 420 is performed as new (empirical) operational data is generated (e.g., through operation of the particular quantum processor) and/or provided to the quantum noise decoder 400.

The quantum error determination model 420 is configured to provide raw noise model 444 via one or more output layers of the one or more neural networks thereof. The noise model generation module 430 is configured to receive the raw noise model 444 and translate, transform, format, compile, and/or configure the raw noise model 444 into a noise model 446 that is comprehensible to the controller 30 and/or computing entity 10.

The quantum noise decoder 400 then provides an output comprising the noise model 446. The output may be received by one or more applications, programs, modules, and/or the like operating on the controller 30 and/or computing entity 10.

For example, as shown in FIG. 4A, generation of a noise model 446 for the particular quantum processor 115 comprises, in an example embodiment, training the quantum error determination model 420 using operational data at step/operation 402. For example, the quantum noise decoder 400 may receive input 442 comprising (empirical) operational data corresponding to the operation of the particular quantum processor 115. The quantum error determination model 420 is then trained using at least a portion of the input 442 comprising (empirical) operational data corresponding to the operation of the particular quantum processor 115.

For example, a machine learning technique may be used to train the quantum error determination model 420 using training data that includes empirical operational data corresponding to the operation of the particular quantum processor 115. In various embodiments, the training may be an initial training of the quantum error determination model where the initial weights of the one or more DNNs are randomly set or set to selected (e.g., untrained) values. In various embodiments, the training may be a continued training of an already trained quantum error determination model 420 (e.g., using a new batch of training data comprising empirical operational data), where the initial weights of the one or more DNNs are set to previously trained values. For example, the quantum error determination model 420 is iteratively trained, in an example embodiment.

Once training criteria for the quantum error determination model 420 is satisfied (e.g., the loss function used in the machine learning technique is minimized), the raw noise model 444 is read and/or extracted from the output layer(s) of the quantum error determination model 420.

At step/operation 404, the noise model generation module 430 is executed to generate the noise model 446 based on the raw noise model 444 read and/or extracted from the output layer(s) of the quantum error determination model 420. For example, the noise model generation module 430 translates, transforms, formats, compiles, and/or configures the raw noise model 444 into a noise model 446 that is comprehensible to the controller 30 and/or computing entity 10.

At step/operation 406, the quantum noise decoder 400 provides an output comprising the noise model 446 for the particular quantum processor 115. For example, the output including the noise model 446 for the particular quantum processor 115 may be provided by the quantum noise decoder 400 to an application, program, module and/or the like being executed by the processing device 805, 908 via an API call or API response (e.g., when the output is being provided in response to an API call providing the input 442).

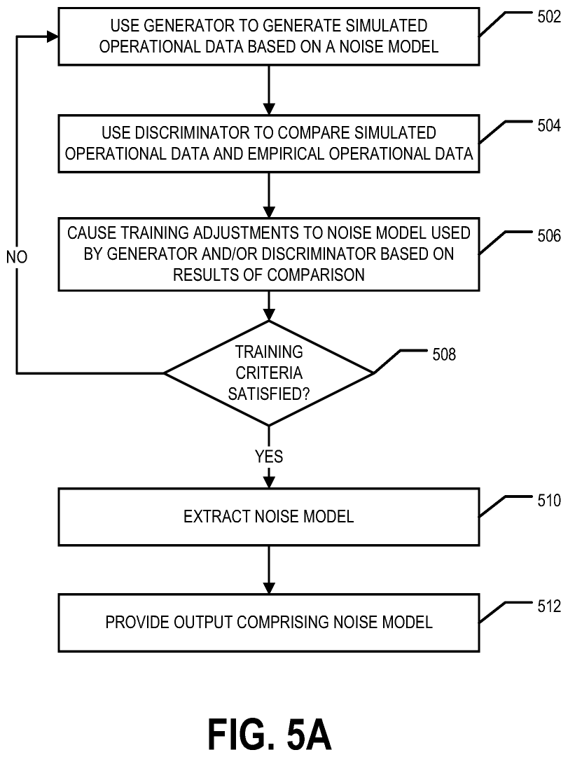

In various embodiments, the quantum noise decoder 400 may have various architectures. In an example embodiment, the quantum noise decoder 400 comprises a generative adversarial network (GAN) and/or a GAN machine-learning technique is used to train the quantum error determination model 420. For example, FIG. 5B illustrates an example quantum noise decoder 500 that uses a GAN architecture for generating a noise model for the noise present in computations performed by a particular quantum processor 115. FIG. 5A provides a flowchart illustrating various processes, procedures, operations, and/or the like for using the quantum noise decoder 400 to generate and/or provide a noise model for the particular quantum processor 115.

In the illustrated embodiment, the quantum noise decoder 500 comprises two or more DNNs in a GAN architecture. For example, the quantum noise decoder 500 comprises a generator 520 and a discriminator 540. The generator 520 comprises a simulation noise model 525 of the particular quantum processor 115 and is configured to generate simulated operational data for the particular quantum processor 115 based at least in part on the simulation noise model 525. The simulated operational data 554 for the particular quantum processor 115 is provided to the discriminator 540.

The discriminator 540 is configured to receive and/or obtain empirical operational data 552 (e.g., from the processing device 805, 908 and/or a program, application, module and/or the like operating on the processing device). The discriminator 540 is further configured to receive and/or obtain simulated operational data 554 generated by the generator 520 based at least in part on the simulation noise model 525. The discriminator 540 is configured to perform a blind analysis, processing, and/or comparison of the simulated operational data 554 for the particular quantum processor and the empirical operational data 552 and determine which data set is the simulated operational data 554 and which data set is the simulated operational data 554.

In various embodiments, the discriminator 540 comprises a quantum error determination model 545. In various embodiments, the quantum error determination model 545 is trained and/or configured to characterize the noise of the particular quantum processor based on operational data corresponding to operation of the particular quantum processor. For example, quantum error determination model 545 are configured to analyze, process, and/or compare the simulated operational data 554 for the particular quantum processor and the empirical operational data 552 for the particular quantum processor. The quantum error determination model 545 may use the analysis, processing, and/or comparison of the simulated operational data 554 for the particular quantum processor and the empirical operational data 552 for the particular quantum processor to characterize the noise of the particular quantum processor.

In various embodiments, the simulation noise model 525 of the generator 520 and the quantum error determination model 545 of the discriminator 540 are trained using a GAN machine learning technique. For example, the training module 560 receives a determination and/or selection from the discriminator 540 of which data set consists of simulation data and which data set consists of empirical data.

Based on whether the determination and/or selection from the discriminator 540 is correct or not, the training module 560 trains the generator 520 to generate simulation operational data that is more similar to the empirical operational data. For example, the training module 560 may cause the simulation noise model 525 to be adjusted, modified, and/or the like to better approximate and/or better reflect the noise present in computations performed by the particular quantum processor 115.

Based on whether the determination and/or selection from the discriminator 540 is correct or not, the training module 560 trains the discriminator 540 to be better able to discriminate between the empirical operational data and the simulation operational data. For example, the quantum error determination model 545 may be trained, modified, adjusted, and/or the like to better characterize the noise present in the empirical operational data.

Once the simulation noise model 525 of the generator 520 and the quantum error determination model 545 of the discriminator 540 are trained such that a convergence requirement is satisfied, the noise model generation model 530 extracts a raw noise model 556 from the generator 520. In an example embodiment, the raw noise model 556 is substantially similar to and/or a copy of the trained simulation noise model 525.

The noise model generation module 530 is configured to receive the raw noise model 556 and translate, transform, format, compile, and/or configure the raw noise model 556 into a noise model 558 that is comprehensible to the controller 30 and/or computing entity 10.

The quantum noise decoder 500 then provides an output comprising the noise model 558. The output may be received by one or more applications, programs, modules, and/or the like operating on the controller 30 and/or computing entity 10.

For example, as shown in FIG. 5A, starting at step/operation 502, the computing entity 10 and/or controller 30 causes the generator 520 to generate simulated operational data 554 based at least in part on the simulation noise model 525. The generator 520 then provides the simulated operational data 554 to the discriminator 540.

The discriminator 540 receives the simulated operational data 554 and the empirical operational data 552 (e.g., provided to the quantum noise decoder 500 at step/operation 204).

At step/operation 504, the computing entity 10 and/or controller 30 causes the discriminator 540 to analyze, process, and/or compare the simulated operational data 554 for the particular quantum processor and the empirical operational data 552 for the particular quantum processor. For example, the discriminator 540 receives the simulated operational data 554 and the empirical operational data 552 as blind data sets. For example, the discriminator 540 receives two data sets that include the simulated operational data 554 and the empirical operational data 552. However, the discriminator 540 receives the two data sets such that the discriminator does not know which of the two data sets is the simulated operational data 554 and which of the two data sets is the empirical operational data 552.

The discriminator 540, using the quantum error determination model 545, selects one of the data sets as the simulated operational data and one of the data sets as the empirical operational data.

At step/operation 506, the computing entity 10 and/or controller 30 causes the training module 560 to make training adjustments to the simulation noise model 525, generator 520, quantum noise determination model 454, and/or discriminator 540 based on whether the discriminator 540 correctly identified the simulated operational data and/or the empirical operational data or not. For example, the training module 560 may use a loss function and/or the like to adjust and/or modify one or more weights and/or parameters of the simulation noise model 525, generator 520, quantum noise determination model 454, and/or discriminator 540.

In various embodiments, the training module 560 is configured to cause the generator 520 to generate simulation operational data that better approximates the empirical operational data. For example, the training module 560 is configured to adjust and/or modify the simulation noise model 525 to better reflect and/or approximate the noise present in computations performed by the particular quantum processor 115. In various embodiments, the training module 560 is configured to cause the discriminator 540 to better discriminate between the simulation operational data and the empirical operational data. For example, the training module 560 is configured to cause the quantum error determination model 545 to better characterize the noise present in computations performed by the particular quantum processor 115.

At step/operation 508, it is determined whether training criteria are satisfied. For example, the computing entity 10 and/or controller 30 (possibly using the training module 560) determines whether the training criteria is satisfied. For example, when the discriminator 540 correctly selects the simulation operational data and/or the empirical operational data a threshold number of consecutive times, when the simulation noise model 525 and/or the quantum error determination model 545 have converged, a loss function of the generator 520 satisfies threshold criteria, and/or the like.

When it is determined, at step/operation 508, that the training criteria is not satisfied, the process returns to step/operation 502 and another round of simulated operational data is generated by the generator such that further training is performed.

When it is determined, at step/operation 508, that the training criteria is satisfied, the process continues to step/operation 510.

At step/operation 510, the computing entity 10 and/or controller 30 causes the noise model generation module 530 to extract the raw noise model 556 from the generator 520 and generate the noise model 558 based on the raw noise model 556. In an example embodiment, the raw noise model is generated based on output of the quantum error determination model 545. In an example embodiment, the noise model generation module 530 translates, transforms, formats, compiles, and/or configures the raw noise model into a noise model 558 that is comprehensible to the controller 30 and/or computing entity 10.

At step/operation 512, the quantum noise decoder 500 provides an output comprising the noise model 558 for the particular quantum processor 115. For example, the output including the noise model 558 for the particular quantum processor 115 may be provided by the quantum noise decoder 500 to an application, program, module and/or the like being executed by the processing device 805, 908 via an API call or API response (e.g., when the output is being provided in response to an API call providing the input empirical operational data 552).

### Example Providing of a Noise Model for a Particular Quantum Processor

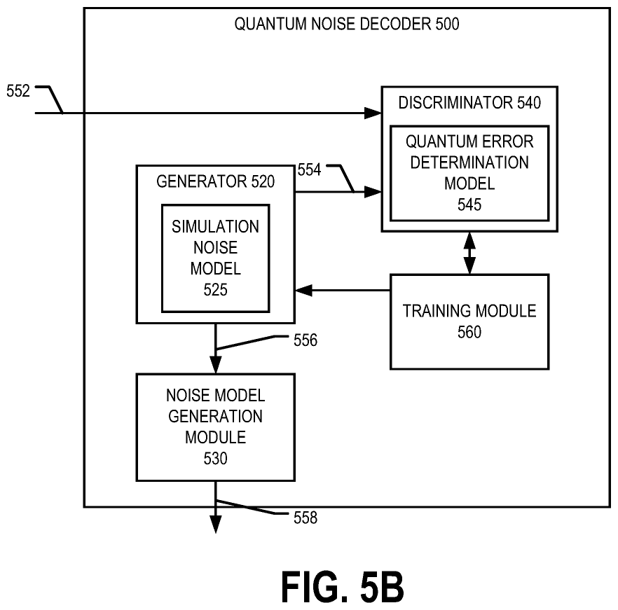

FIG. 6 provides a flowchart illustrating various processes, operations, and/or procedures performed by a controller 30 and/or a computing entity 10, for example, to provide a noise model such that at least one component and/or parameter of the quantum processor is modified, changed, adjusted, and/or the like by a human technician based on the noise model, according to various embodiments. In various embodiments, the processes, procedures, and/or operations of FIG. 6 are performed as part of step/operation 208.

Starting at step 602, a graphical representation of at least a portion of the noise model is generated. For example, the controller 30 (e.g., via processing device 805) and/or the computing entity 10 (e.g., via processing device 908) generates a graphical representation of at least a portion of the noise model. For example, the memory 810, 922, 924 may comprise computer-executable instructions configured to, when executed by processing device 805, 908, cause the noise model to be processed and the graphical representation thereof to be generated. In various embodiments, the graphical representation of the at least a portion of the noise model is configured to communicate and/or illustrate information corresponding to the noise model, noise-related trends identified in the operational data, and/or the like to a human user. For example, the graphical representation of the at least a portion of the noise model is configured to make the at least a portion of the noise model human readable and/or comprehensible.

In various embodiments, the graphical representation may provide a plot illustrating the frequency profile of noise present in electrical signals applied to the potential generating elements of the confinement apparatus 120; wavelength/frequency fluctuations, phase shifts, and/or optical power fluctuations in various manipulation signals; magnitude, direction, and/or frequency profiles of magnetic field fluctuations at one or more locations within the confinement apparatus 120; variations in quantum state readings of a cohort of physical qubits that are used as logical qubit and/or a cohort of spectator objects; and/or the like as indicated by the noise model. The graphical representation may include plots showing and/or illustrating trends in various noise types and/or contributors over time, as indicated by the noise model.

In various embodiments, the graphical representation of the portion of the noise model may indicate a portion of the quantum processor to which a given plot corresponds. For example, a set of plots illustrating wavelength/frequency fluctuations, phase shifts, and/or optical power fluctuations in various manipulation signals; magnitude, direction, and/or frequency profiles of magnetic field fluctuations at one or more locations within the confinement apparatus 120 when two qubit gate manipulation signals are applied to the one or more locations include an indication that the set of plots correspond to application of two qubit gate manipulation signals, identify the one or more locations, and/or the like.

At step/operation 604, the controller 30 and/or the computing entity 10 cause the graphical representation of the noise model to be displayed via a GUI of a display (e.g., display 916). A human technician may review and/or analyze the graphical representation as displayed (e.g., via a GUI of display 916) and, based at least in part thereon, modify, adjust, change, and/or the like at least one component and/or parameter of the quantum processor 115 in a manner that is expected to and/or in an attempt to reduce the noise in the computations performed by the particular quantum processor. For example, the human technician may change out a burnt out optical fiber, adjust the alignment of a mirror or lens, and/or the like based on a contribution to the noise of the particular quantum processor identified and/or indicated by the noise model.

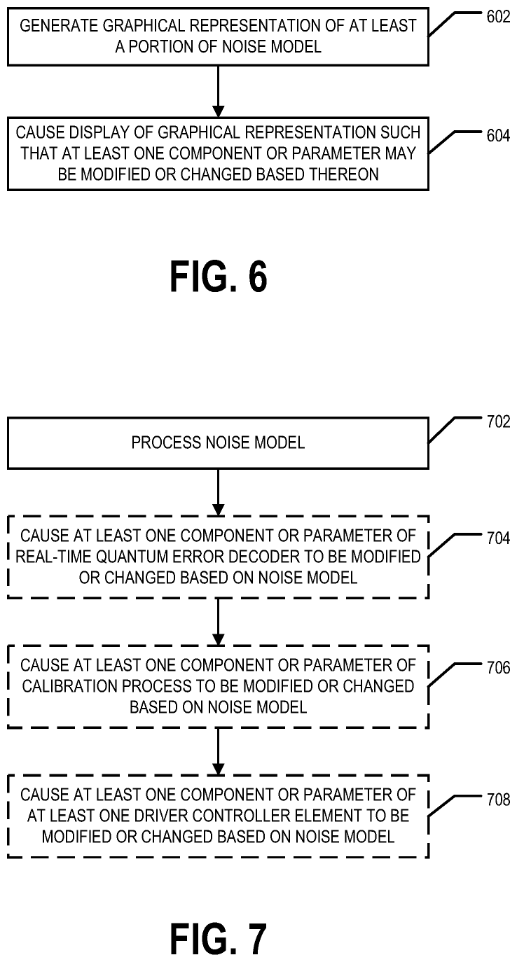

FIG. 7 provides a flowchart illustrating various processes, operations, and/or procedures performed by a controller 30 and/or a computing entity 10, for example, to provide a noise model such that at least one component and/or parameter of the quantum processor is automatically modified, changed, adjusted, and/or the like based on the noise model, according to various embodiments. In various embodiments, the processes, procedures, and/or operations of FIG. 7 are performed as part of step/operation 208.

Starting at step/operation 702, the noise model is processed to determine whether and/or identify any components and/or parameters may be automatically modified, adjusted, changed, and/or the like to reduce the noise (e.g., reduce the amplitude of noise in one or more noise profiles provided by the noise model, reduce the presence of a particular feature present in one or more noise profiles provided by the noise model, and/or the like) experienced by the particular quantum processor 115 as characterized by the noise model. In an example embodiment, the controller 30 and/or computing entity 10 processes the noise model to determine whether there are components and/or parameters that may be automatically modified, adjusted, changed, and/or the like in an attempt to reduce the noise (e.g., reduce the amplitude of noise in one or more noise profiles provided by the noise model, reduce the presence of a particular feature present in one or more noise profiles provided by the noise model, and/or the like) experienced by the particular quantum processor 115.

For example, the machine-learning trained quantum error determination model and/or noise model generation module is configured to identify likely noise sources for the sub-system of the particular quantum processor 115, in an example embodiment. In such an embodiment, the noise model identifies the identified likely noise sources. For example, the noise model may include an indication that an optical fiber or waveguide along a particular optical path may be burnt out or that the alignment of optical elements along a particular optical path may need to be addressed. The noise model may then be processed with a knowledge of what modifications, adjustments, changes and/or the like may be automatically performed and which require human technician intervention. For example, a human technician may be needed to switch out a burnt optical fiber. However, an automated alignment process may be defined and/or programmed such that the controller 30 is capable of performing an automated alignment of a particular optical path (or at least a portion thereof). In another example, one or more software component and/or modifications may be automatically performed (e.g., updating a parameter of a calibration process, providing a noise profile to a real-time quantum error decoder, and/or the like).

When modifications, adjustments, changes, and/or the like to at least one component and/or parameter that are likely and/or expected to reduce the noise (e.g., reduce the amplitude of noise in one or more noise profiles provided by the noise model, reduce the presence of a particular feature present in one or more noise profiles provided by the noise model, and/or the like) present in computations performed by the particular quantum processor 115 the controller 30 and/or computing entity 10 may cause the performance of one or more such automated modifications, adjustments, changes, and/or the like. For example, the controller 30 of the quantum computer may modify, adjust, change, and/or the like at least one component and/or parameter of the quantum processor (e.g., adjust a hardware component and/or parameter, software component and/or parameter, and/or a calibration component and/or parameter) based on the noise model.

For example, at step/operation 704, the controller 30 and/or computing entity 10 may cause at least one component and/or parameter of a real-time quantum error decoder to be modified, adjusted, changed, and/or the like based on the noise model. For example, the real-time quantum error decoder may be used to perform real-time quantum error correction during the operation of the particular quantum processor 115. The at least one component and/or parameter of the real-time quantum error decoder is modified, adjusted, changed, and/or the like based on the noise model such that the real-time quantum error decoder is more accurate at determining, accounting for, and/or correcting the quantum errors during the operation of the particular quantum processor 115. For example, the real-time quantum error decoder may be used to determine qubit phase shifts that need to be accounted for during execution of a quantum circuit. Thus, in an example embodiment, at least one component and/or parameter of the real-time quantum error decoder may be modified, adjusted, changed, and/or the like based on the noise model such that more accurate qubit phase shifts are determined, for example.

In another example, at step/operation 706, the controller 30 and/or computing entity 10 may cause at least one component and/or parameter of a calibration process to be modified, adjusted, changed, and/or the like based on the noise model. For example, a particular calibration process may be performed more frequently, a new calibration process may be developed and put into use, a parameter used in a calibration process may be updated, and/or the like.

In another example, at step/operation 708, the controller 30 and/or computing entity 10 may cause at least one component and/or parameter of a driver controller element 815 to be modified, adjusted, changed, and/or the like based at least in part on the noise model. For example, when the noise model indicates that the noise in a voltage signal being provided by a particular voltage source 50 is particularly high, the corresponding driver controller element 815 may be modified, adjusted, changed, and/or the like to cause filtering of the voltage signal provided by the particular voltage source in a manner that reduces the noise observed in the voltage signal. In another example, the technique for performing a function of the quantum computer (e.g., performing a single or two qubit gate, performing a transportation operation, performing a reading operation, and/or the like), may be modified, updated, changed, and/or the like based on the noise model and/or a result of processing and/or analyzing the noise model so as to reduce the noise present in computation performed by the particular quantum processor 115. For example, a component and/or parameter of a driver controller element 815 may be modified, adjusted, changed, and/or the like such that a particular manipulation source 60 may be driven in a slightly different manner during the performance of the function of the quantum computer.

### Technical Advantages

Large-scale quantum computers are expected to solve problems that are currently intractable with today's technology, such as in the fields of chemistry, material science, and biology. Solving such problems will entail computations employing quantum algorithms implemented using deep quantum circuits. Obtaining the necessary levels of accuracy for these deep circuits requires high levels of reliability for the quantum operations. To achieve such reliability, quantum error correction (QEC) will be employed during computations to suppress noise to required levels. However, to suppress the noise present within a particular quantum processor to the required levels, it is helpful to understand the noise present in the particular quantum processor.

As used herein, a particular quantum processor corresponds to a particular instance of hardware and the configuration of that hardware to provide the particular quantum processor. For example, in the field of quantum charge-coupled device (QCCD)-based quantum computing, a particular quantum processor corresponds to a particular ion trap, the magnetic field generation components, manipulation sources (e.g., lasers), the optical paths defined to provide manipulation signals (e.g., laser beams) to respective locations of the particular ion trap, and/or the like. For example, if a particular mirror or lens of an optical path is slightly out of alignment or an optical fiber defining a portion of an optical path is nearly burnt out, the manipulation signal provided along the optical path may carry less optical power than expected and/or result in uncompensated shifts in optical phase of the manipulation signal. Thus, the functions performed using the optical path contribute to the noise of the particular quantum processor. However, a second quantum processor of similar design would not experience that particular contribution to the noise of the second quantum processor.

Current techniques for managing noise in a quantum processor include the use of real-time quantum error decoders. However, due to the time constraints for performing real-time quantum error correction while executing a quantum circuit, current real-time quantum error decoders tend to be simple programs that rely on algorithms such as the blossom algorithm or Dijkstra's algorithm. These real-time quantum error decoders are generally not able to provide a broader characterization of the noise of a particular quantum processor and may rely on generic noise models that fail to characterize noise contributions that are distinct and/or specific to the particular quantum processor with which the real-time quantum error decoder is associated. Therefore, there exist technical problems in the field of characterizing the noise of a quantum processor and using a noise model that characterizes the noise of a quantum processor to perform quantum error correction (including real-time quantum error correction) for a quantum processor.

Various embodiments provide technical solutions to these technical problems. In particular, various embodiments provide a quantum noise decoder that comprises a machine-learning based quantum error determination model that is trained, using a machine-learning technique, to characterize the noise of the particular quantum processor. The quantum noise decoder (e.g., the machine-learning based quantum error determination model) is trained using operational data (e.g., empirical operational data) corresponding to and/or generated during operation of a particular quantum processor. The quantum noise decoder is then used to generate a noise model that characterizes the noise of the particular quantum processor.

Based on the noise for the particular quantum processor, at least one component and/or parameter of the quantum processor may be modified, adjusted, changed, and/or the like to reduce the noise in the computations performed by the particular quantum processor. For example, a graphical representation of at least a portion of the noise model for the particular quantum processor may be displayed via a graphical user interface (GUI) and/or the like provided via the display of a computing entity such that a human technician may modify, adjust, change, and/or the like at least one component and/or parameter. For example, the human technician may change out a burnt out optical fiber, adjust the alignment of a mirror or lens, and/or the like based on a contribution to the noise of the particular quantum processor identified and/or indicated by the noise model. For example, the controller of the quantum computer may modify, adjust, change, and/or the like at least one component and/or parameter of the quantum processor (e.g., adjust a hardware component and/or parameter, software component and/or parameter, and/or a calibration component and/or parameter) based on the noise model. In an example embodiment, the noise model is provided to the real-time quantum error decoder for use in performing real-time quantum error correction for the particular quantum processor.

Thus, various embodiments provide methods, apparatuses, systems, computer program products, and/or the like for determining a noise model that characterizes the noise of a particular quantum processor. Various embodiments provide methods, apparatuses, systems, computer program products, and/or the like for reducing the noise of a particular quantum processor based on a determined noise model that characterizes the noise of the particular quantum processor. Various embodiments therefore provide practical applications that provide technical solutions and technical advantages to quantum computing, including the fields of quantum error correction, real-time quantum error correction, quantum processor noise reduction, and/or the like.

### Example Controller

In various embodiments, a controller 30 of a quantum computer 110 is configured to control operation of various components, elements, assemblies, and/or the like of a quantum processor 115. For example, in various embodiments, the controller 30 is configured to control the voltage sources 50, cryostat system and/or vacuum system controlling the temperature and pressure within the cryostat and/or vacuum chamber 40, manipulation sources 60, and/or other systems controlling various environmental conditions (e.g., temperature, pressure, magnetic field, and/or the like) within the cryostat and/or vacuum chamber 40 and/or configured to manipulate and/or cause a controlled evolution of quantum states of one or more atomic objects within the confinement apparatus. In various embodiments, the controller 30 is configured to cause performance of one or more calibration processes to generate calibration data corresponding to the operation of the quantum processor 115 and/or to modify, adjust, change, and/or the like one or more components and/or parameters of the quantum processor 115 based at least in part on the noise model for the particular quantum processor 115.

As shown in FIG. 8, in various embodiments, the controller 30 comprises various controller elements including processing device 805, memory 810, driver controller elements 815, a communication interface 820, analog-digital converter elements 825, and/or the like. For example, the processing device 805 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 805 of the controller 30 comprises a clock and/or is in communication with a clock.

For example, the memory 810 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 810 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 810 (e.g., by a processing device 805) causes the controller 30 to perform one or more steps, operations, processes, procedures and/or the like described herein for tracking the phase of an atomic object within an atomic system and causing the adjustment of the phase of one or more manipulation sources and/or signal(s) generated thereby.

In various embodiments, the driver controller elements 815 may include one or more drivers and/or controller elements each configured to control one or more drivers. In various embodiments, the driver controller elements 815 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 805). In various embodiments, the driver controller elements 815 may enable the controller 30 to operate a manipulation source 60. In various embodiments, the drivers may be laser drivers; vacuum component drivers; drivers for controlling the flow of current and/or voltage (e.g., voltage sources 50) of an electrical signal applied to potential generating elements (e.g., electrodes) of the confinement apparatus 120; cryogenic and/or vacuum system component drivers; and/or the like.

In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter elements 825 configured to receive signals from one or more optical receiver components, calibration sensors, and/or the like.

In various embodiments, the controller 30 comprises a communication interface 820 for interfacing and/or communicating with one or more computing entities 10. For example, the controller 30 may comprise a communication interface 820 for receiving executable instructions, command sets, noise models, and/or the like from the computing entity 10 and providing output received from the quantum computer 110 (e.g., from an optics collection system 70) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

FIG. 9 provides an illustrative schematic representative of an example computing entity 10 that can be used in conjunction with embodiments of the present disclosure. In various embodiments, a computing entity 10 is a classical (e.g., semiconductor-based) computer configured to allow a user to provide input to the quantum computer 110 (e.g., via a user interface of the computing entity 10) and receive, display, analyze, and/or the like output from the quantum computer 110.

As shown in FIG. 9, a computing entity 10 can include an antenna 912, a transmitter 904 (e.g., radio), a receiver 906 (e.g., radio), and a processing device 908 that provides signals to and receives signals from the transmitter 904 and receiver 906, respectively. In various embodiments, the processing device 908 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products.

The signals provided to the transmitter 904 from the processing device 908 and received from the receiver 906 by the processing device 908, may include signaling information/data in accordance with an air interface standard of applicable wireless systems to communicate with various entities, such as a controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 916 and/or speaker/speaker driver coupled to a processing device 908 and a touch screen, keyboard, mouse, and/or microphone coupled to a processing device 908). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
training, by one or more processors, a quantum noise decoder comprising a machine-learning trained quantum error determination model using training data comprising operational data captured based at least in part on operation of a particular quantum processor;
generating, by the one or more processors a noise model for the particular quantum processor based on the machine-learning trained quantum error determination model; and
providing, by the one or more processors, the noise model, wherein providing the noise model comprises at least one of (a) causing a graphical representation of at least a portion of the noise model to be provided via a display of a computing entity such that at least one component or parameter of the particular quantum processor is modified or changed based thereon or (b) providing at least a portion of the noise model as input associated with executable instructions for execution by a controller of the particular quantum processor or a computing entity in communication with the controller of the particular quantum processor such that at least one component or parameter of the particular quantum processor is modified or changed based thereon.

2. The method of claim 1, wherein the operational data comprises calibration data generated through operation of the particular quantum processor.

3. The method of claim 2, wherein the calibration data is captured periodically during operation of the particular quantum processor.

4. The method of claim 1, wherein the operational data comprises spectator objects data captured through direct or indirect observation of one or more spectator objects controlled by the particular quantum processor, the one or more spectator objects controlled independently of a quantum algorithm being executed by the particular quantum processor.

5. The method of claim 1, wherein the quantum noise decoder comprises a generative adversarial network (GAN) comprising a generator and a discriminator and the generator is configured to generate simulated operational data.

6. The method of claim 5, wherein the discriminator comprises or is in communication with the machine-learning trained quantum error determination model.

7. The method of claim 1, wherein the quantum noise decoder comprises a noise model generation module configured to generate the noise model for the particular quantum processor based at least in part on output of the machine-learning trained quantum error determination model.

8. The method of claim 1, wherein the at least one component or parameter is part of or used by a real-time quantum error decoder to correct for quantum errors during operation of the particular quantum processor.

9. The method of claim 1, wherein at least one component or parameter is a hardware component or a physical parameter of the particular quantum processor.

10. The method of claim 1, wherein the at least one component or parameter corresponds to a re-calibration of a hardware component of the particular quantum processor or a software process of the controller of the particular quantum processor.

11. The method of claim 1, wherein the quantum noise decoder is a real-time quantum error decoder configured to cause correction of quantum errors during operation of the particular quantum processor.

12. The method of claim 1, wherein the noise model characterizes noise present in the operational data for the particular quantum processor.

13. An apparatus comprising at least one non-transitory memory storing computer-executable instructions and a processing device, the computer-executable instructions, when executed by the processing device, configured to cause the apparatus to at least:
train a quantum noise decoder comprising a machine-learning trained quantum error determination model using training data comprising operational data captured based at least in part on operation of a particular quantum processor;
generate a noise model for the particular quantum processor based on the machine-learning trained quantum error determination model; and
provide the noise model, wherein providing the noise model comprises at least one of (a) causing a graphical representation of at least a portion of the noise model to be provided via a display of a computing entity such that at least one component or parameter of the particular quantum processor is modified or changed based thereon or (b) providing at least a portion of the noise model as input associated with executable instructions for execution by a controller of the particular quantum processor or a computing entity in communication with the controller of the particular quantum processor such that at least one component or parameter of the particular quantum processor is modified or changed based thereon.

14. The apparatus of claim 13, wherein the operational data comprises at least one of: (a) calibration data generated through operation of the particular quantum processor or (b) spectator objects data captured through direct or indirect observation of one or more spectator objects controlled by the particular quantum processor, the one or more spectator objects controlled independently of a quantum algorithm being executed by the particular quantum processor.

15. The apparatus of claim 13, wherein the quantum noise decoder comprises a generative adversarial network (GAN) comprising a generator and a discriminator and the generator is configured to generate simulated operational data.

16. The apparatus of claim 15, wherein the discriminator comprises or is in communication with the machine-learning trained quantum error determination model.

17. The apparatus of claim 13, wherein the at least one component or parameter (a) is part of or used by a real-time quantum error decoder to correct for quantum errors during operation of the particular quantum processor, (b) is a hardware component or a physical parameter of the particular quantum processor, or (c) corresponds to a re-calibration of a hardware component of the particular quantum processor or a software process of the controller of the particular quantum processor.

18. The apparatus of claim 13, wherein the quantum noise decoder is a real-time quantum error decoder configured to cause correction of quantum errors during operation of the particular quantum processor.

19. The apparatus of claim 13, wherein the noise model characterizes noise present in the operational data for the particular quantum processor.

20. The apparatus of claim 13, wherein the apparatus is a controller of the particular quantum processor or in communication with the controller of the particular quantum processor.
